(19) United States
(12) Patent Application Publication
(10) Pub. No.: US 2007/0180287 A1
(43) Pub. Date: Aug. 2, 2007

(54) System and method for managing node resets in a cluster

(75) Inventors: Ravi D. Kumar, Austin, TX (US); Peyman Najafirad, Austin, TX (US)

Correspondence Address: BAKER BOTTS, LLP, 910 LOUISIANA, HOUSTON, TX, 77002-4995, US

(73) Assignee: Dell Products L. P., Round Rock, TX (US)

(21) Appl. No.: 11/343,777

(22) Filed: Jan. 31, 2006

(51) Int. Cl. G06F 11/00

(52) U.S. Cl. 714/4

(57) ABSTRACT

A method of managing node resets in a cluster is provided. Status information from a node cluster including a plurality of nodes may be received. A determination of whether a time delay associated with a first node of the cluster is greater than a node reset time may be made based at least on the received status information. The node reset time may comprise a time after which a node reset is automatically triggered. If the time delay associated with the first node is greater than the node reset time, the node reset time may be dynamically adjusted such that a node reset of the first node is not automatically triggered.

### TECHNICAL FIELD

The present disclosure relates generally to information handling systems and, more particularly, to a system and method for managing node resets in a cluster.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Groups of information handling systems are often arranged in cluster configurations. In some clusters, such as an ORACLE Real Application™ cluster, for example, a group of nodes may be connected to a storage device such that the nodes may store data in, and retrieve data from, the storage device. Such configuration may be referred to as shared storage. In some shared storage configurations, such as where the storage device includes multiple zones for data storage, redundant communication paths may be used in order to increase the reliability, or robustness, of the system (e.g., to provide maximum high availability architecture). In some configurations, for example, if Node A has a problem (e.g., becomes hung), data from Node A may be flushed from Node A to Node B. Node B may know the operations Node A was performing and may take over and complete the operation for Node A. The data may then be flushed into storage. In such situation, data loss may thus be avoided.

In some shared cluster configurations, such as some active-active cluster configurations, I/O fencing is used to help preserve the integrity of the shared cluster by shutting down hung, or potentially hung, nodes. For example, if one node stops emitting its “heartbeat” (i.e., the signal that verifies to the other nodes that it is functioning properly), the I/O fencing system may send a signal to shut down or reset that node to avoid data corruption. If the downed node comes back online (e.g., in a reset situation), it has the potential to corrupt the shared data or file system and/or take control of the cluster, which may lead to data loss and/or various system failures. Shutting down a node according to I/O fencing is often referred to as “Shoot the Other Machine in the Head,” or STOMITH.

In a cluster configuration using redundant communication paths, the failure of one or more paths (e.g., due to LUN trespass, switch or storage SP failure) under heavy I/O loading conditions may trigger I/O fencing to shut down or reset a node unnecessarily. For example, if the timing for switching from a failed path to an operational path (which may be referred to as the “path failover interval”) is greater than the timing for delay allowed by the I/O fencing system before triggering a node shut down or reset (which may be referred to as a “hang check margin” or a “hang check timer”), the I/O fencing shut down or reset may be triggered unnecessarily. Such unnecessary node shut down/reset may be inefficient, expensive, and/or may lead to other system problems.

### SUMMARY

Therefore, a need has arisen for systems and methods for allowing the grouping of resource objects in a directory services authentication/authorization schema, while maintaining access query functionality.

In accordance with one embodiment of the present disclosure, a method of managing node resets in a cluster is provided. Status information from a node cluster including a plurality of nodes may be received. A determination of whether a time delay associated with a first node of the cluster is greater than a node reset time may be made based at least on the received status information. The node reset time may comprise a time after which a node reset is automatically triggered. If the time delay associated with the first node is greater than the node reset time, the node reset time may be dynamically adjusted such that a node reset of the first node is not automatically triggered.

In accordance with another embodiment of the present disclosure, software encoded in computer-readable media is provided. When executed by a processor, the software may be operable to: receive status information from a node cluster including a plurality of nodes; determine, based at least on the received status information, whether a time delay associated with a first node of the cluster is greater than a node reset time, the node reset time comprising a time after which a node reset is automatically triggered; and if the time delay associated with the first node is greater than the node reset time, dynamically adjusting the node reset time such that a node reset of the first node is not automatically triggered.

In accordance with yet another embodiment of the present disclosure, an information handling system may include a node reset management system. The node reset management system may be operable to receive status information from a node cluster, the node cluster including a plurality of nodes. The node reset management system may be further operable to determine, based at least on the received status information, whether a time delay associated with a first node of the cluster is greater than a node reset time. The node reset time may comprise a time after which a node reset is automatically triggered. The node reset management system may be further operable, if the time delay associated with the first node is greater than the node reset time, to dynamically adjust the node reset time such that a node reset of the first node is not automatically triggered.

One technical advantage of the present disclosure is that systems and methods for managing node resets in a cluster environment, including preventing or reducing unnecessary node resets. In prior systems, all delays that exceed a hang check time may trigger node resets, whether or not a node reset is required. For example, a node reset may be triggered due to delays caused by a path failover operation, which node reset is often unnecessary and thus undesirable. The systems and methods may avoid or reduce such unnecessary node resets, which may increase system efficiency, reduce expenses, and/or prevent or reduce other system problems.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example configuration of a cluster according to one embodiment of the present disclosure;

FIG. 2 illustrates an example method for managing the reset of cluster nodes, according to one embodiment of the disclosure; and

FIG. 3 illustrates an example method for managing the reset of cluster nodes in a path failover situation, according to one embodiment of the disclosure.

### DETAILED DESCRIPTION

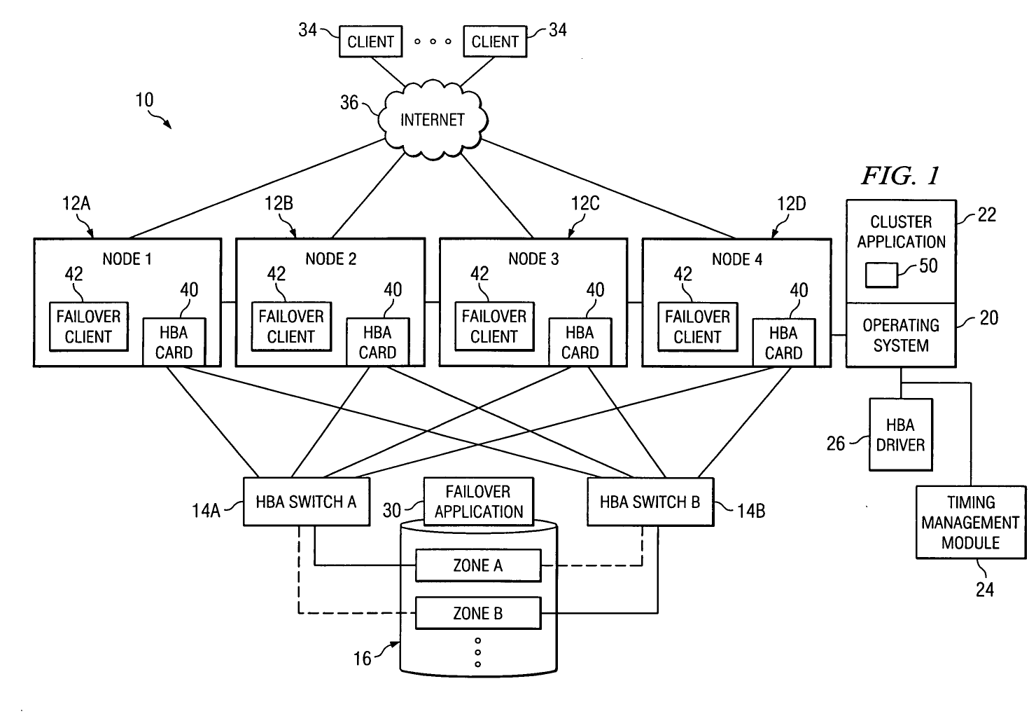

Preferred embodiments and their advantages are best understood by reference to FIGS. 1-3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

FIG. 1 illustrates an example configuration of a cluster 10 according to one embodiment of the present disclosure. A cluster may include, for example, a number of nodes, a storage, and/or any number of intermediate components (e.g., switches or routers) connected between the nodes and the storage. In this example configuration, cluster 10 may include four cluster nodes 12 (nodes 12A-12D), two switches 14 (switches 14A and 14B), and a storage system 16. Such configuration may be referred to as a 4-node cluster, and may be representative, for example, of a typical ORACLE™ cluster.

Cluster 10 may further include an operating system (OS) 20, a cluster application 22, a timing management module 24, and one or more switch drivers 26. In addition, a redundancy application 30 may be stored in or otherwise associated with storage system 16. One or more nodes 12 may be communicatively coupled to one or more clients 34 via one or more communication networks 36 such that clients 34 may communicate with storage system 16 via the components of cluster 10. Each component of cluster 10 may include one or more information handling systems.

Nodes 12 may include any information handling system suitable to perform the functions discussed herein, such as a server, for example. Each node 12 may include a switch interface card 40, a redundancy application client 42, and any other interfaces (e.g., NICs) suitable for allowing communications between one or more other components of cluster 10. Switch interface card 40 may include any card or device configured to allow for interconnection with a switch or other intermediate component of cluster 10. In an example embodiment, switch interface card 40 comprises an HBA card located in a PCI slot. Redundancy application client 42 may include any application or module configured to cooperate with redundancy application 30, as discussed below.

Switches 14 may include any switch or router devices configured to provide connectivity between, and to switch or route data communications between, nodes 12 and storage system 16. In some embodiments, switches 14 may comprise HBA switches, e.g., QLOGIC™ or EMULEX™ switches.

Storage system 16 may include any memory, database(s), or other storage devices operable to store data. Storage system 16 may be divided into zones (or otherwise) in order to provide redundant or more efficient storage. For example, as shown in FIG. 1, storage system 16 includes a database divided into Storage Zone A and Storage Zone B. In an example embodiment, storage system 16 may comprise a CLARION CX™ storage system.

Operating system 20 may include any suitable operating system for cluster 10, e.g., WINDOWS™, MAC OS™, or UNIX™.

Cluster application 22 may interrelate with operating system 20 and may comprise any application operable to provide cluster management functions. In one example embodiment, cluster application 22 comprises an ORACLE™ cluster application.

Cluster application 22 may include a cluster management module 50 operable to provide load-balancing functions and/or to protect cluster 10 (e.g., storage system 16) from data corruption. For example, cluster management module 50 may include I/O fencing functions or algorithms to shut down one, some, or all nodes 12 and/or other components of cluster 10 (which may be referred to as node reset) in the event of a node failure (e.g., a hung node) in order to reduce the likelihood of data corruption that may be caused by the failed node. In some embodiments, cluster management module 50 directs a functional node 12 to shut down or reset a problematic (e.g., hung) node 12. Such I/O fencing may be referred to as “shooting the other machine in the head” (STOMITH). Shooting down of one node may lead to a chain reaction in which all nodes in cluster are shut down or reset, in an attempt to avoid data corruption.

In some embodiments, I/O fencing may be automatically triggered after a node 12 has been inactive (e.g., hung or not responding) for a particular time period. Such time period may be referred to as a “node reset time” or a “hang check margin.” For example, supposing the value of the hang check margin defined by cluster management module 50 is 10 seconds, if Node 1 appears hung for 10 seconds (e.g., Node 1 fails to send out its normal status signal for 10 seconds), I/O fencing may be triggered and Node 2 may shoot down Node 1, which may lead to a chain reaction in which all nodes 12 (here, Nodes 1-4) are shut down/reset.

In prior systems, the value of the hang check margin (e.g., in seconds or milliseconds) may be a static (e.g., hard-coded) value defined by cluster protection module 50. As discussed below in greater detail, according to the present disclosure, the value of the hang check margin may be dynamically adjusted, which may help avoid unnecessary system shutdowns/resets, which system shutdowns/resets may be expensive and/or inefficient.

Timing management module 24 may include any suitable software, executable code, hardware, and/or firmware, operable to communicate with cluster management module 50 to dynamically manage the value of the hang check margin, e.g., to help avoid unnecessary system shutdowns/resets, based on status information regarding one or more components of cluster 10, which may be received in real time or substantially in real time. In some embodiments, timing management module 24 may determine whether to dynamically change the value of the current or default hang check margin, and to instruct cluster management module 50 (e.g., via an Ack message) to implement such changes when appropriate. In other embodiments, timing management module 24 may adjust the hang check margin itself.

For example, based on status information received from one or more components of cluster 10, timing management module 24 may be notified or may determine that one or more components are experiencing a problem or performing an operation that may take longer to complete/resolve than the current or default value for the hang check margin, but that should not trigger I/O fencing. Examples of such situations include (a) high-traffic situations in which one or more components may be running slowly, but properly, or (b) situations in which a component (e.g., a switch) fails and a path failover operation is required to reroute communications between one or more nodes 12 and storage system 12 (discussed below in greater detail). In such situations, cluster operations may be slow or delayed, but the cluster need not be shut down (e.g., as there is no particular concern of data corruption), and thus shutting down/resetting the cluster may be unnecessary. In such situations, timing management module 24 may instruct cluster management module 50 to dynamically increase the value of the hang check margin to prevent the I/O fencing from being triggered. Thus, timing management module 24 may be able to prevent or reduce the likelihood of unnecessary cluster shut down/reset, which shut down/reset may be inefficient, expensive, and/or may lead to other system problems.

Timing management module 24 may be completely separate from, partially integrated with, or fully integrated with cluster application 22.

Switch driver 26 may comprise any driver or other similar application for one or more switches 14. For example, switch driver 26 may comprise an HBA driver.

Clients 34 may comprise any one or more network clients. For example, a client may be a home computer, workstation, server, computer terminal, PDA, cell phone, etc., having a web browser, and cluster 10 may be associated with an online shop or vendor accessible by the client 34 via the client's web browser.

Communication network 36 may include, or be a associated with, any local area network (LAN), metropolitan area network (MAN), wide area network (WAN), wireless local area network (WLAN), virtual private network (VPN), intranet, Internet, any suitable wireless or wireline links, or any other appropriate architecture or system that facilitates communications between one or more clients 34 and cluster 10.

Redundancy application 30 may include any application or module configured to provide for redundant communications paths or links in cluster 10. In an example embodiment, redundancy application 30 may comprise a POWERPATH™ application by EMC™. As in FIG. 1, redundancy application 30 may be configured to provide and/or manage zoned storage in storage system 30. Redundancy application 30 may divide storage system 30 into multiple zones and allow communication of data to and from such zones via different switches 14. For example, as shown in FIG. 1, storage system 16 may include a database divided into Storage Zone A and Storage Zone B, and redundancy application 30 may associate Switch A (14A) with Storage Zone A and Switch B (14B) with Storage Zone B such that communications to and from Storage Zone A are routed through Switch A, and communications to and from Storage Zone B are routed through Switch B. Each node 12 may be connected to each switch 14 (via multiple ports provided by each switch interface card 40) such that data communications between each particular node 12 and storage system 16 can be configured to be routed through any switch 14 and storage zone.

In some embodiments, such routing configurations can be changed over time, e.g., to avoid failed or off-line components (e.g., a faulty switch). For example, redundancy application 30 may comprise a storage failover application 30 and redundancy application client 42 may comprise a storage failover client configured to cooperate with the storage failover application 30 in order to manage the redirection or re-routing of communications in cluster 10 when one or more components of cluster 10 fail. Such failures may include, for example, LUN trespass, switch failure, or storage system failure. In some applications, such redirection or re-routing of communications may be referred to as “failover” or “path failover.”

For instance, in the configuration shown in FIG. 1, suppose Node 1 is configured to store data in/access data from storage system 16 via Switch B. If Switch B fails (e.g., becomes hung), storage failover application 30 may identify the failure and, in response, initiate a path failover operation to reroute the communication path between Node 1 and storage system 16 through Switch A (rather than Switch B). Identifying the switch failure and/or executing the path failover may take a period of time, which may be referred to as the “time to failover.” In some embodiments, the time to failover may be a static value defined by storage failover application 30 (e.g., the time to failover may be hard-coded in the failover software).

In some situations, there may be a mismatch between the “hang check margin” defined by cluster management module 50 and the “time to failover” defined by storage failover application 30. For example, the time to failover is greater than the current or default hang check margin. In such situations, timing management module 24 may dynamically increase the value of the hang check margin to prevent the node reset (e.g., I/O fencing) from being triggered. Thus, timing management module 24 may be able to prevent or reduce the likelihood of the cluster being unnecessarily shut down or reset due to the delays associated with the path failover.

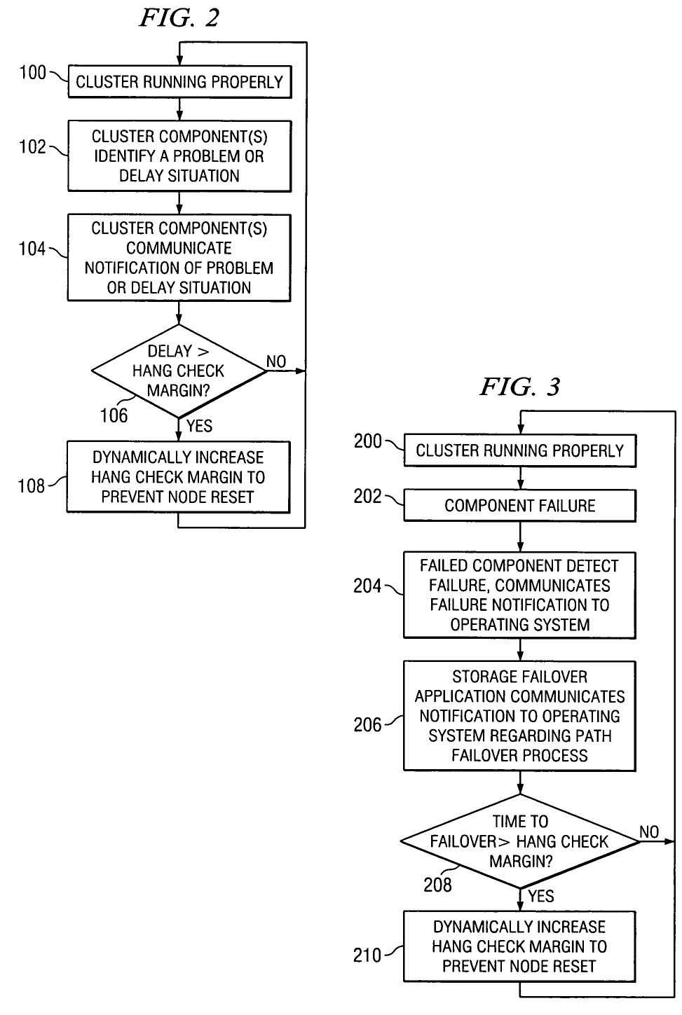

FIG. 2 illustrates an example method for managing the reset of nodes 12 in a cluster 10, according to one embodiment of the disclosure. At step 100, cluster 10 is running properly. For example, nodes 12 may be communicating data to and from storage system 16 without significant delays. At step 102, one or more components of cluster 10 may identify a problem or situation with one or more components may cause a delay in the operation of such component(s), such as a high-traffic situations causing one or more components to run slowly or a component (e.g., a switch) failure that will trigger or has triggered a path failover operation, for example. In some embodiments, hardware of one or more components may detect such problem or situation.

At step 104, the one or more components that identified the problem or delay situation may communicate information to cluster management module 50 and/or timing management module 24 indicating the status and/or condition of the problematic/delayed component(s).

At step 106, cluster management module 50 or timing management module 24 may determine based on the information received at step 104 whether the particular problem or delay situation will cause a delay greater than the current or default hang check margin, but should not trigger a reset of the node or cluster. For example, in a heavy load situation, cluster management module 50 or timing management module 24 may determine (based on information received at step 104) that Node 1 will be tied up in an operation for 10 seconds, which exceeds the default hang check margin is 5 seconds. As another example, cluster management module 50 or timing management module 24 may determine (based on information received at step 104) that a path failover that will tie up Node 2 for 8 seconds is under way, which exceeds the default hang check margin is 5 seconds.

At step 108, based on the determination made at step 106, timing management module 24 may instruct cluster management module 50 to dynamically increase the value of the hang check margin to exceed the delay caused by the particular problem or delay situation, thus preventing a node reset from being triggered. For example, in the heavy load situation discussed above, timing management module 24 may increase the hang check margin from 5 seconds to 11 seconds, such that a reset of Node 1 is not triggered. As another example, in the failover situation discussed above, timing management module 24 may instruct cluster management module 50 to increase the hang check margin from 5 seconds to 9 seconds, such that a reset of Node 2 is not triggered. The method may then return to step 100.

In this manner, unnecessary cluster shut down/reset may be avoided or reduced, which may increase system efficiency, reduce expenses, and/or prevent or reduce other system problems.

FIG. 3 illustrates an example method for managing the reset of nodes 12 in a cluster 10 in a path failover situation, according to one embodiment of the disclosure. At step 200, cluster 10 is running properly. At step 202, a component of cluster 10 fails (such as a component between nodes 12 and storage system 16, e.g., an HBA card 40, an HBA switch 14, a processor within storage system 16 (e.g., SSB), or a LUN). At step 204, the failed component (or another component) may detect its failure and communicates a notification to OS 20 indicating the failure.

At step 206, storage failover application 30 may communicate a notification to OS 20 indicating that a path failover will be/has been initiated, as well as the “time to failover.” At step 208, cluster management module 50 or timing management module 24 may determine whether the time to failover is greater than the current or default hang check margin.

If it is determined at step 208 that the time to failover is greater than the current or default hang check margin, at step 210, timing management module 24 may increase the hang check margin (e.g., by instructing cluster management module 50 or by effecting the increase itself) such that a reset of Node 2 (e.g., by I/O fencing) is not triggered. The method may then return to step 100. Alternatively, if it is determined at step 208 that the time to failover is less than the current or default hang check margin, node reset will not be triggered and the method may return to step 100.

In this manner, unnecessary cluster shut down/reset due to path failover may be avoided or reduced, which may increase system efficiency, reduce expenses, and/or prevent or reduce other system problems.

Although the disclosed embodiments have been described in detail, it should be understood that various changes, substitutions and alterations can be made to the embodiments without departing from their spirit and scope.

What is claimed is:

1. A method of managing node resets in a cluster, comprising:
receiving status information from a node cluster, the node cluster including a plurality of nodes;
determining, based at least on the received status information, whether a time delay associated with a first node of the cluster is greater than a node reset time, the node reset time comprising a time after which a node reset is automatically triggered; and
if the time delay associated with the first node is greater than the node reset time, dynamically adjusting the node reset time such that a node reset of the first node is not automatically triggered.

2. A method according to claim 1, wherein the node reset time is predetermined.

3. A method according to claim 1, wherein:
receiving status information from a node cluster comprises receiving a notification of a path failover process, the path failover process comprising a process or re-routing communications in the cluster due to the failure of one or more components of the cluster; and
determining whether a time delay associated with a first node of the cluster is greater than a node reset time comprises determining whether a time associated with the path failover process is greater than the node reset time.

4. A method according to claim 3, wherein:
the node cluster comprises a storage system, a first switch, and a second switch, and first and second switches providing for redundant communication links between the nodes and the storage system; and
the path failover process comprises re-routing communications between at least one node and the storage system through the second switch due to a failure of the first switch.

5. A method according to claim 1, further comprising:
determining, based on the received status information, whether a node reset should be triggered; and
dynamically adjusting the node reset time only if it is determined that the node reset should not be triggered; and
not dynamically adjusting the node reset time only if it is determined that the node reset should be triggered.

6. A method according to claim 1, wherein dynamically adjusting the node reset time comprises:
determining a time difference between the node reset time and the time delay associated with the first node; and
increasing the node reset time by at least the determined time difference.

7. A method according to claim 1, wherein the time delay associated with a first node of the cluster is caused by a heavy traffic situation.

8. Software encoded in computer-readable media and when executed by a processor, operable to:
receive status information from a node cluster, the node cluster including a plurality of nodes;
determine, based at least on the received status information, whether a time delay associated with a first node of the cluster is greater than a node reset time, the node reset time comprising a time after which a node reset is automatically triggered; and
if the time delay associated with the first node is greater than the node reset time, dynamically adjusting the node reset time such that a node reset of the first node is not automatically triggered.

9. Software according to claim 8, wherein the node reset time is predetermined.

10. Software according to claim 8, wherein:
receiving status information from a node cluster comprises receiving a notification of a path failover process, the path failover process comprising a process or re-routing communications in the cluster due to the failure of one or more components of the cluster; and
determining whether a time delay associated with a first node of the cluster is greater than a node reset time comprises determining whether a time associated with the path failover process is greater than the node reset time.

11. Software according to claim 10, wherein:
the node cluster comprises a storage system, a first switch, and a second switch, and first and second switches providing for redundant communication links between the nodes and the storage system; and
the path failover process comprises re-routing communications between at least one node and the storage system through the second switch due to a failure of the first switch.

12. Software according to claim 8, further operable to:
determine, based on the received status information, whether a node reset should be triggered; and
dynamically adjust the node reset time only if it is determined that the node reset should not be triggered; and
not dynamically adjust the node reset time only if it is determined that the node reset should be triggered.

13. Software according to claim 8, wherein dynamically adjusting the node reset time comprises:
determining a time difference between the node reset time and the time delay associated with the first node; and
increasing the node reset time by at least the determined time difference.

14. Software according to claim 8, wherein the time delay associated with a first node of the cluster is caused by a heavy traffic situation.

15. An information handling system comprising a node reset management system operable to:
receive status information from a node cluster, the node cluster including a plurality of nodes;
determine, based at least on the received status information, whether a time delay associated with a first node of the cluster is greater than a node reset time, the node reset time comprising a time after which a node reset is automatically triggered; and
if the time delay associated with the first node is greater than the node reset time, dynamically adjust the node reset time such that a node reset of the first node is not automatically triggered.

16. An information handling system according to claim 15, wherein:
receiving status information from a node cluster comprises receiving a notification of a path failover process, the path failover process comprising a process or re-routing communications in the cluster due to the failure of one or more components of the cluster; and
determining whether a time delay associated with a first node of the cluster is greater than a node reset time comprises determining whether a time associated with the path failover process is greater than the node reset time.

17. An information handling system according to claim 16, wherein:
the node cluster comprises a storage system, a first switch, and a second switch, and first and second switches providing for redundant communication links between the nodes and the storage system; and
the path failover process comprises re-routing communications between at least one node and the storage system through the second switch due to a failure of the first switch.

18. An information handling system according to claim 15, wherein the node reset management system is further operable to:
determine, based on the received status information, whether a node reset should be triggered; and
dynamically adjust the node reset time only if it is determined that the node reset should not be triggered; and
not dynamically adjust the node reset time only if it is determined that the node reset should be triggered.

19. An information handling system according to claim 15, wherein dynamically adjusting the node reset time comprises:
determining a time difference between the node reset time and the time delay associated with the first node; and
increasing the node reset time by at least the determined time difference.

20. An information handling system according to claim 15, wherein the time delay associated with a first node of the cluster is caused by a heavy traffic situation.
